(19) United States
(12) Patent Application Publication
(10) Pub. No.: US 2002/0114879 A1
(43) Pub. Date: Aug. 22, 2002

(54) Self-regulated method and system for curing of reactive materials

(76) Inventor: Steve Martin, Toronto (CA)

Correspondence Address: Shawn D. Jacka, Bereskin & Parr, Box 401, 40 King Street West, Toronto, ON, M5H 3Y2, CA

(21) Appl. No.: 09/846,237

(22) Filed: May 2, 2001

Related U.S. Application Data
(60) Provisional application No. 60/276,140, filed on Mar. 16, 2001.
(60) Provisional application No. 60/269,864, filed on Feb. 21, 2001.

(51) Int. Cl. B05D 3/00

(52) U.S. Cl. 427/8; 427/487

(57) ABSTRACT

A method and system for curing reactive materials. The system includes a generator capable of generating radiation, a power supply operatively coupled to the generator, and an emitter adapted to emit the generated radiation onto the material. The system also includes a temperature sensor capable of detecting the temperature of the material and generating corresponding temperature data and a controller adapted to control the power level of radiation emitted. The controller is configured to receive the temperature data signals and detect a variation in the rate of change in the temperature of the material being cured. The controller is also configured to adjust the power level of radiation emitted upon detecting a variation in the rate of change in the temperature of the material being cured. The method includes the steps of generating radiation; directing radiation at a first power level onto the reactive material; monitoring to detect a variation in the change of temperature of the material being cured; upon detecting a variation in the change of temperature of the material being cured, adjusting the power level at which radiation is emitted onto the material being cured until it is substantially cured.

### CROSS-REFERENCE TO RELATED APPLICATIONS

This application claims the benefit of Provisional Applications Serial No. 60/276,140, filed Mar. 16, 2001 and Serial No. 60/269,864, filed Feb. 21, 2001

### FIELD OF THE INVENTION

The present invention relates generally to the field of curing polymeric materials, typically in the class of thermosets, with common but by no means exclusive application to manufacturing techniques involving reactive adhesives. For greater clarity, when used herein, “curable materials” and variations thereof are intended to mean polymeric materials which chemically transform with the application of sufficient energy, unless a contrary intention is apparent.

### BACKGROUND OF THE INVENTION

Curable materials, such as photoreactive adhesives, are commonly used in manufacturing applications. The process of curing such reactive materials generally involves the supplying of energy to the reactive material to initiate the desired and frequently exothermic chemical reaction; however, in providing the energy to the material, it is necessary to carefully monitor the temperature and avoid thermal runaway which ultimately results in the burning of the material.

A wide variety of curable adhesives exist. The selection of an adhesive for a specific application depends on various uncured and cured properties, including viscosity, pot-life, cure time, post-cure strength and hardness, chemistry (affecting which materials can be bonded), shrinkage, and density. The curing characteristics of the adhesive, such as curing time and temperature, depend on the chemical composition of the adhesive as well as its volume.

Prior art techniques for curing reactive materials typically require knowledge of a curing profile for the material to be cured, including the rate or power level at which energy is to be delivered to the material over time. In general, the determination of a curing profile (of which many variations may exist), which achieves acceptable curing results, requires extensive testing of different power levels and cure durations. However, if the composition, shape or quantity of the curable material changes to even a small degree, generally a new curing profile must be determined. Otherwise, an unsatisfactory cure or thermal runaway may result.

Accordingly, the inventors have recognized a need for a system and method which is capable of automatically adjusting a cure cycle to satisfactorily cure reactive material, despite variations in the quantity or shape of the material.

### SUMMARY OF THE INVENTION

This invention is directed towards a system and method for curing reactive materials.

Specifically, the subject invention is directed towards a method of curing reactive material. The method includes the steps of:

(a) generating radiation within the absorption spectrum of the reactive material;

(b) directing radiation at a first power level onto the reactive material;

(c) monitoring to detect a change in the rate of temperature increase of the reactive material; and

(d) upon detecting a change in the rate of temperature increase of the reactive material, directing radiation substantially at a second power level onto the reactive material until the reactive material is substantially cured.

The invention is further directed towards an alternate method of curing reactive material. The steps of this method include:

(a) generating radiation within the absorption spectrum of the reactive material;

(b) directing radiation at a first power level onto the reactive material;

(c) monitoring to detect a variation in the rate of temperature change of the reactive material; and

(d) upon detecting a variation in the rate of temperature change of the reactive material, adjusting the rate at which radiation is directed onto the reactive material to maintain the temperature of the reactive material below a predetermined maximum temperature until the reactive material is substantially cured.

The invention is also directed towards a system for curing reactive material. The system comprises a generator capable of generating radiation within the absorption spectrum of the reactive material, a power supply operatively coupled to the generator, and a temperature sensor capable of detecting the temperature of the reactive material and generating temperature data signals correlated to the detected temperature. The system also includes a controller adapted to control the amount of power supplied to the generator. The controller is configured to receive the temperature data signals and to detect a variation in the rate of change in the temperature of the reactive material. The controller is also configured to adjust the amount of power supplied to the generator upon the controller detecting a variation in the rate of change in the temperature of the reactive material.

Additionally, the invention is directed towards an alternate system for curing reactive material. The alternate system comprises a generator capable of generating radiation within the absorption spectrum of the reactive material, a power supply operatively coupled to the generator, an emitter adapted to direct the generated radiation onto the reactive material, and a temperature change sensor capable of detecting the rate of temperature change of the reactive material and generating data signals correlated to the detected rate of temperature change. The alternate system also includes a controller adapted to control the amount of power supplied to the generator wherein the controller is responsive to the data signals such that the amount of power supplied to the generator is varied upon detection of a variation in the rate of temperature change of the reactive material.

Furthermore, the present invention is directed to another alternate system for curing reactive material. This second alternate system comprises a generator capable of generating radiation within the absorption spectrum of the reactive material, a power supply operatively coupled to the generator, an emitter adapted to emit the generated radiation onto the reactive material, and a temperature sensor capable of detecting the temperature of the reactive material and generating temperature data signals correlated to the detected temperature. The second alternate system also includes a controller configured to receive the temperature data signals and configured to detect a variation in the rate of change in the temperature of the reactive material, as well as means responsive to the controller for varying the rate of radiation emitted by the emitter upon detection by the controller of a variation in the rate of temperature change of the reactive material.

### BRIEF DESCRIPTION OF THE DRAWINGS

The present invention will now be described, by way of example only, with reference to the following drawings, in which like reference numerals refer to like parts and in which:

FIG. 1 is a front perspective view of an embodiment of the curing system made in accordance with the present invention.

FIG. 2 is a cross-sectional schematic diagram of the light delivery module of FIG. 1.

FIG. 3 is a logical flow diagram of the method carried out by the curing system made in accordance with the present invention.

FIG. 4 is a graph illustrating the change in temperature of reactive material being cured in accordance with the present invention.

### DESCRIPTION OF THE PREFERRED EMBODIMENTS

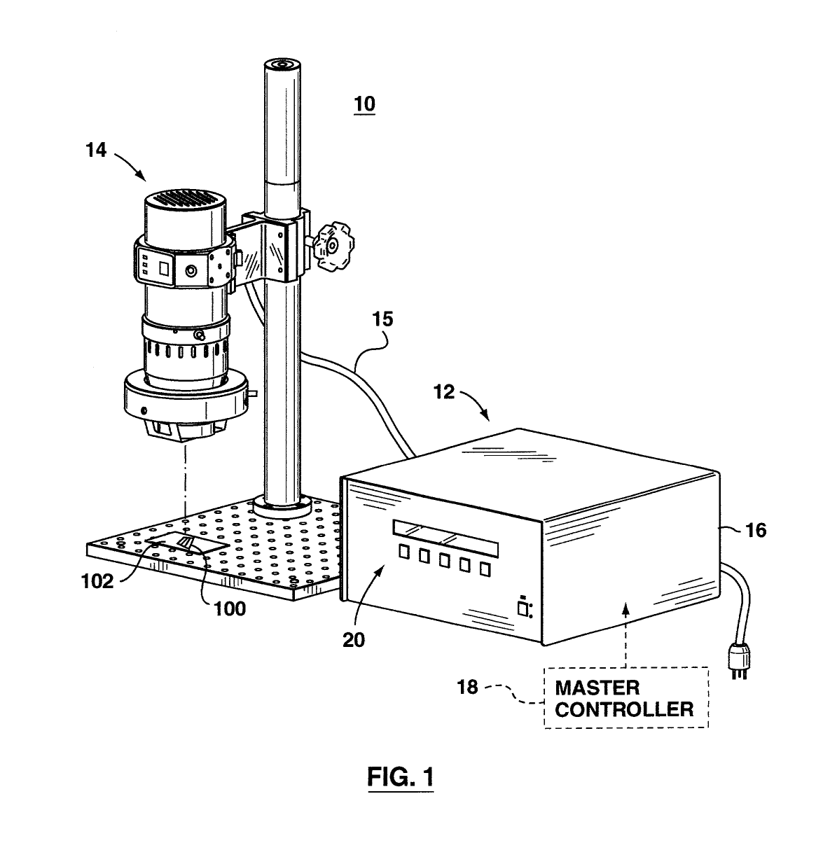

Referring simultaneously to FIGS. 1 & 2, illustrated therein is a preferred embodiment of the curing system of the subject invention. The curing system, shown generally as 10, comprises a base unit 12 and a light delivery module 14 (LDM). The base unit 12 and the light delivery module 14 are operatively coupled together by cabling 15 to enable the exchange of data and the supply of power from the base unit 12 to the LDM 14, as will be discussed in greater detail, below.

The base unit 12 includes a base unit housing 16, a master controller 18 and a control data interface 20 having keypads and a display for enabling a user to input control instructions and data into the system 10 via the master controller 18. The master controller 18 contains a suitably programmed central processing unit and memory, as will be understood.

The module 14 includes a housing 26 in which are contained the LDM controller 28, a power supply 30, a non-contact worksite temperature sensor 32, a light source or generator 34, an internal temperature sensor 36, a fan 38 and an emitter assembly 40.

The power supply 30 is configured to provide power to the light source 34, and typically is electrically coupled to the base unit 12 which in turn obtains power through a standard electrical plug. In turn, the LDM controller 28 is operatively coupled to the power supply 30 and to the light source 34, to control the supply of power to the light source 34 throughout a curing cycle.

Preferably the light source 34 is configured to generate broadband infrared radiation, and typically includes a tungsten halogen lamp. As will be understood, the light source 34 also includes a reflector often coated with gold or aluminum to reflect light having longer wavelengths.

The emitter assembly 40 includes a lens 41 for focusing the generated light radiation onto the curable material 100 positioned on the workpiece 102. Preferably the lens is made of calcium fluoride which is capable of transmitting a broad range of infrared wavelengths. The emitter assembly 40 also preferably includes a replaceable filter 42 for selecting the emission of specific spectral bands of radiation that can be more precisely matched to the absorption spectrum of the material to be cured. As well, the emitter assembly 40 may also include a shutter mechanism 43 for regulating the amount of energy emitted by the LDM 14, in place of regulating the power to the light source 34.

For applications involving most types of curable adhesives, preferably the light source 34 and emitter 40 are selected to generate and emit infrared radiation within the range of 3 to 5 micrometers. This range largely overlaps the high absorption region of large number of curable materials, including many adhesives.

The LDM controller 28 is operatively linked to the master controller 18, and is also electrically connected to the non-contact worksite temperature sensor 32. The non-contact temperature sensor 32 is configured to monitor the temperature of the curable material 100 throughout the cure cycle. The temperature sensor 32 typically monitors blackbody radiation, which is proportional to the temperature, emitted by the curable material 100, and generates corresponding temperature data which is received by the LDM controller 28.

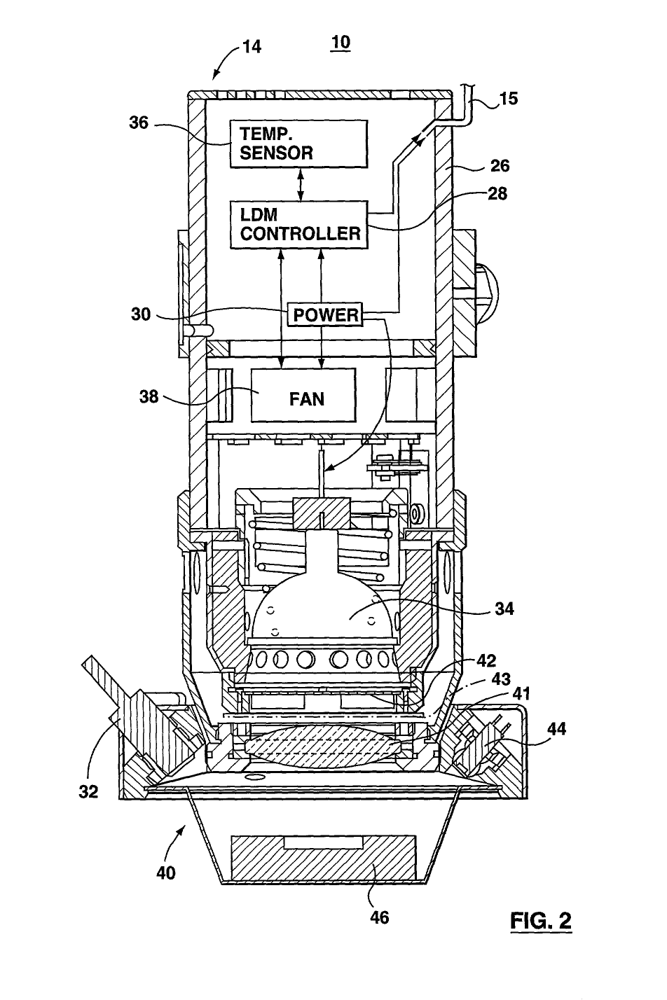

Preferably the LDM 14 also includes a targeting system including three low-power visible lasers 44 (one of which is visible in FIG. 2) aligned such that their beams intersect at the focal point of the light source 34. Such a targeting capability is useful, since the infrared radiation emitted by the LDM 14 is invisible.

Additionally, the LDM 14 preferably has a radiometry system 46 configured to monitor the power level of the radiation generated by the light source 34 for calibrating the LDM 14 and confirming that the LDM 14 is delivering the expected quantity of energy to the workpiece 102.

As will be understood, the LDM controller 28 is also operatively coupled to the internal temperature sensor 36 and controls the operation of the fan 38 to maintain the internal temperature of the LDM 14 including the light source 34, within acceptable operating parameters.

The LDM controller 28, comprising a central processing unit and memory as will be understood, is programmed to receive temperature data signals from the non-contact temperature sensor 32 and calculate the rate at which the temperature of the curable material 100 is changing during the cure cycle.

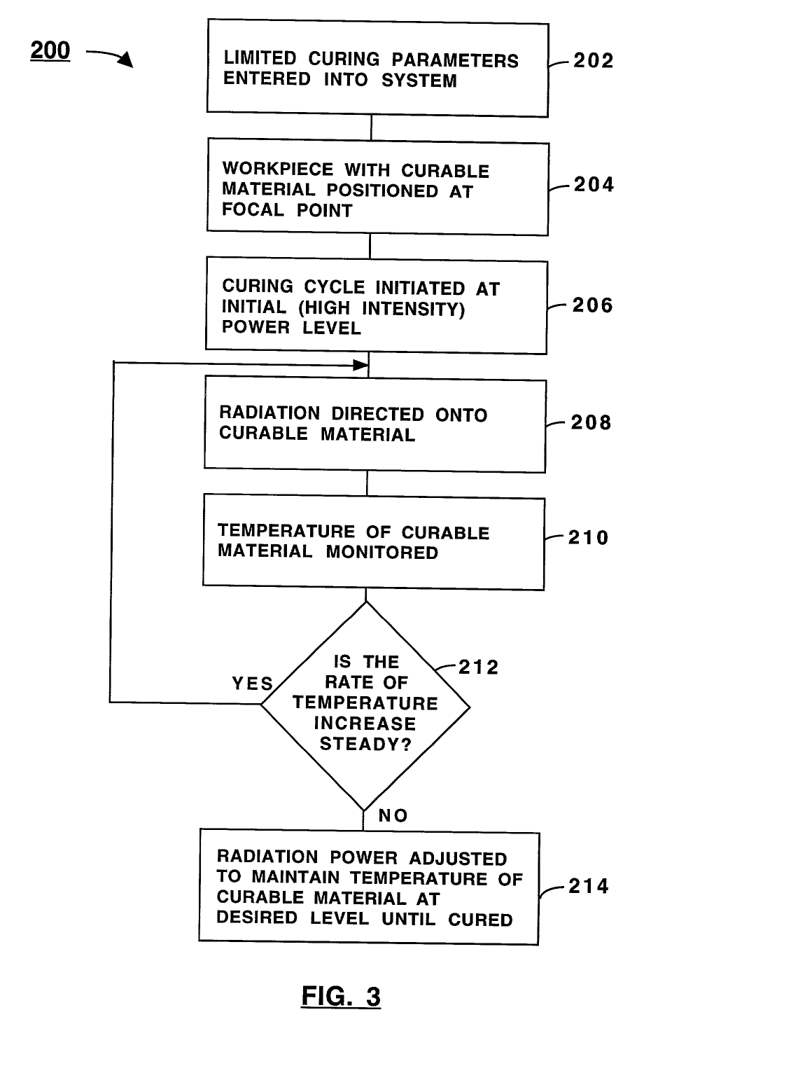

FIG. 3 illustrates the steps of the method 200 carried out by the curing system 10 in use and made in accordance with the subject invention. The user typically first preprograms the system 10 (and specifically the LDM controller 28) using the control data interface 20, with limited curing parameters for the curing cycle (Block 202). This limited curing parameter data includes the initial power level for the initial high intensity radiation stage, the desired curing temperature, and the minimum cure period, all correlated to the specific curable material 100 to be cured. This limited curing parameter data also preferably includes the absorption spectrum of the curable material 100. Preferably, the filters 42 will be configured to selectively emit radiation within this absorption spectrum.

The workpiece 102 having the curable material is typically then appropriately positioned at the system's 10 focal point (Block 204). This positioning step may be carried out by the user manually, using the targeting laser system 44, or will preferably be carried out by an automated manufacturing system using a conveyor belt, manipulator arms or other mechanism, as will be understood.

The curing cycle is then initiated with the LDM controller 28 causing the power supply 30 to provide sufficient power to the light source 34 to generate radiation substantially at the initial power level for the initial high intensity stage (Block 206). This radiation is directed onto the curable material 100 by the emitter module 40 (Block 208). For greater clarification, although the term “curing cycle” is used herein and is intended to mean the entire time in which energy is directed onto the curable material 100, this is to be distinguished from the onset of cure which occurs partway through the curing cycle, as will be discussed in greater detail below.

In accordance with the method of the present invention, during the initial high intensity stage, the non-contact temperature sensor 32 monitors the temperature of the curable material 100 and generates corresponding temperature data which is received by the LDM controller 28 (Block 210). The LDM controller 28 then determines the rate at which the temperature of the curable material 100 is increasing. Alternatively, as will be understood, the temperature sensor 32 may automatically determine the rate of temperature increase and simply forward corresponding data to the controller 28. Based on this data, the controller 28 then determines if the rate of temperature increase is steady (Block 212). If the rate is steady, the non-contact temperature sensor continues to direct radiation at the high intensity power level onto the curable material at Block 208 and to monitor the temperature of the curable material at Block 210.

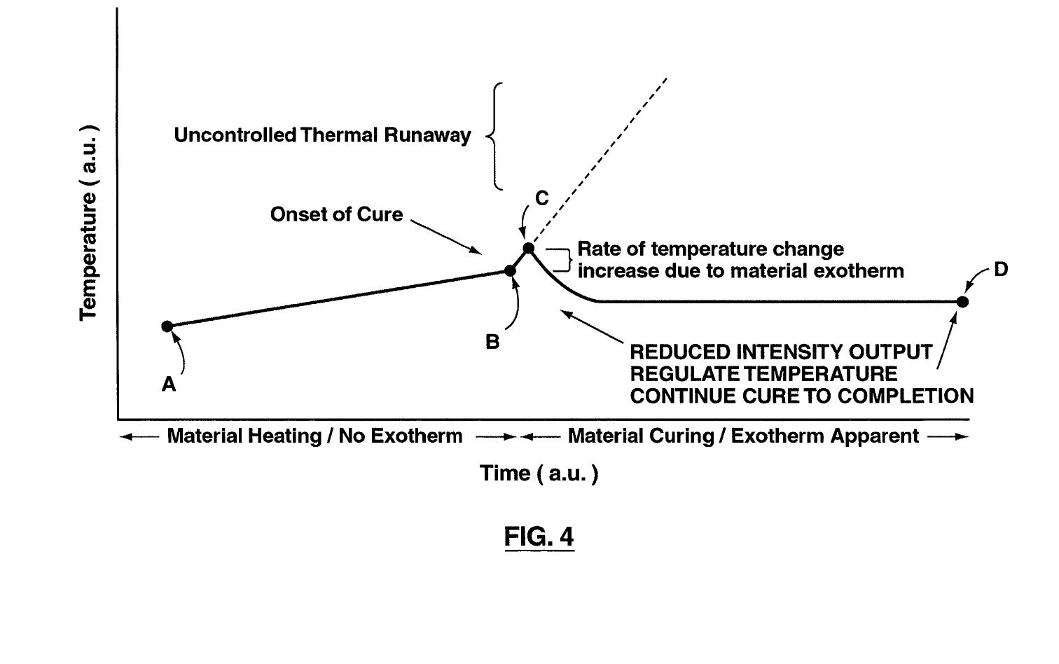

Referring now to FIG. 4, the graph illustrates the rate of increase in temperature of the workpiece during the initial high intensity stage (beginning at point A and continuing to point B). Prior to the onset of cure, curable materials receiving energy at a constant power level typically increase in temperature at a steady rate, as illustrated by the straight line on the graph between points A and B.

However, once the curable material 100 has received a sufficient quantity of energy, the material 100 commences its chemical transformation, which marks the onset of cure. This chemical transformation is typically exothermic. At the onset of cure (at point B on FIG. 4), the exothermic reaction causes a rapid increase in the rate of temperature increase of the curable material 100 (as illustrated by the sharp increase in the slope of the line starting at point B). Unchecked, this increase in the rate of temperature increase would result in thermal runaway (indicated by the dotted line on the graph) thereby burning the curable material 100.

Referring again to FIG. 3, once the LDM controller 28 detects the increase in the rate of temperature increase (at about point B on FIG. 4), the controller 28 reduces the rate at which energy is directed onto the curable material 100, and adjusts this rate to maintain the temperature of the curable material 100 substantially at the preprogrammed desired curing temperature, for the preprogrammed minimum curing period (Block 214). This segment of the curing cycle is illustrated by the straight line on the graph between points C and D. As will be understood, the LDM controller 28 may adjust the rate of energy directed onto the curable material 100 by adjusting the amount of power supplied to the light source 34 and hence the power of the radiation generated, or by adjusting the shutter 43 to affect the quantity of energy emitted by the emitter 40 by the light source 34. Additionally, for manufacturing applications in which the cure cycle is repeated with similar quantities of curable material, the LDM controller 28 may be programmed to store data from successive curing cycles and use that data to “learn” to anticipate the timing of and more promptly detect the onset of cure (point B).

As will be understood, length of the minimum curing period of Block 210 during which energy is directed onto the curable material 100 at a lower intensity is determined by pretesting larger quantities of curable material of the same composition, and determining the quantity of time required to sufficiently cure such larger quantities at the desired curing temperature.

As will also be understood by one skilled in the art, while the LDM controller 28 and the master controller 18 have been described as two separate but operatively coupled devices, one single controller may be used in place of the two controllers 28, 18. Alternatively, the computational functions may be performed by the master controller 18, instead of the LDM controller 28.

Thus, while what is shown and described herein constitute preferred embodiments of the subject invention, it should be understood that various changes can be made without departing from the subject invention, the scope of which is defined in the appended claims.

I claim:

1. A method of curing reactive material, the method comprising the following steps:
(a) generating radiation within the absorption spectrum of the reactive material;
(b) directing radiation at a first power level onto the reactive material;
(c) monitoring to detect a change in the rate of temperature increase of the reactive material; and
(d) upon detecting a change in the rate of temperature increase of the reactive material, directing radiation substantially at a second power level onto the reactive material until the reactive material is substantially cured.

2. The method as claimed in claim 1, wherein step (d) comprises monitoring the temperature of the reactive material and adjusting the power level of the directed radiation to maintain the temperature of the reactive material at approximately a predetermined curing temperature until the reactive material is substantially cured.

3. The method as claimed in claim 2, wherein step (d) further comprises adjusting the power level of radiation generated.

4. The method as claimed in claim 1, wherein step (c) comprises detecting an increase in the rate of temperature increase of the reactive material.

5. The method as claimed in claim 1, further comprising the step of determining the amount of time required to substantially cure at the second power level once the onset of cure has been detected, a quantity of the reactive material at least as large as the quantity of reactive material being cured.

6. The method as claimed in claim 5, wherein step (d) comprises directing radiation substantially at the second power level onto the reactive material for substantially the determined amount of time.

7. The method as claimed in claim 1, wherein step (d) comprises monitoring the temperature of the reactive material and adjusting the power level of the emitted radiation to maintain the temperature of the reactive material substantially at a predetermined curing temperature until the reactive material is substantially cured.

8. The method as claimed in claim 7, further comprising the step of determining the amount of time required to substantially cure at the second power level once the onset of cure has been detected, a quantity of the reactive material at least as large as the quantity of reactive material to be cured.

9. The method as claimed in claim 1, wherein the radiation comprises energy falling within the range of 3 micrometers to 5 micrometers in wavelength.

10. The method as claimed in claim 1, wherein the reactive material is an adhesive.

11. A method of curing reactive material, the method comprising the following steps:
(a) generating radiation within the absorption spectrum of the reactive material;
(b) directing radiation at a first power level onto the reactive material;
(c) monitoring to detect a variation in the rate of temperature change of the reactive material; and
(d) upon detecting a variation in the rate of temperature change of the reactive material, adjusting the rate at which radiation is directed onto the reactive material to maintain the temperature of the reactive material below a predetermined maximum temperature until the reactive material is substantially cured.

12. A system for curing reactive material, the system comprising:
(a) a generator capable of generating radiation within the absorption spectrum of the reactive material;
(b) a power supply operatively coupled to the generator;
(c) a temperature sensor capable of detecting the temperature of the reactive material and generating temperature data signals correlated to the detected temperature;
(d) a controller adapted to control the amount of power supplied to the generator;
(e) wherein the controller is configured to receive the temperature data signals; and
(f) wherein the controller is configured to detect a variation in the rate of change in the temperature of the reactive material and wherein the controller is configured to adjust the amount of power supplied to the generator upon the controller detecting a variation in the rate of change in the temperature of the reactive material.

13. The system as claimed in claim 12, further comprising an emitter adapted to direct the generated radiation onto the reactive material;

14. A system for curing reactive material, the system comprising:
(a) a generator capable of generating radiation within the absorption spectrum of the reactive material;
(b) a power supply operatively coupled to the generator;
(c) an emitter adapted to direct the generated radiation onto the reactive material;
(d) a temperature change sensor capable of detecting the rate of temperature change of the reactive material and generating data signals correlated to the detected rate of temperature change;
(e) a controller adapted to control the amount of power supplied to the generator;
(f) wherein the controller is responsive to the data signals such that the amount of power supplied to the generator is varied upon detection of a variation in the rate of temperature change of the reactive material.

15. A system for curing reactive material, the system comprising:
(a) a generator capable of generating radiation within the absorption spectrum of the reactive material;
(b) a power supply operatively coupled to the generator;
(c) an emitter adapted to emit the generated radiation onto the reactive material;
(d) a temperature sensor capable of detecting the temperature of the reactive material and generating temperature data signals correlated to the detected temperature;
(e) a controller configured to receive the temperature data signals;
(f) wherein the controller is configured to detect a variation in the rate of change in the temperature of the reactive material; and
(g) means responsive to the controller for varying the rate of radiation emitted by the emitter upon detection by the controller of a variation in the rate of temperature change of the reactive material.
